(19) United States
(12) Patent Application Publication
(10) Pub. No.: US 2006/0265454 A1
(43) Pub. Date: Nov. 23, 2006

(54) Instant message methods and techniques to broadcast or join groups of people

(75) Inventors: Randolph Michael Forlenza, Austin, TX (US); John Paul Kaemmerer, Pflugerville, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/133,421

(22) Filed: May 19, 2005

(51) Int. Cl. G06F 15/16

(52) U.S. Cl. 709/206

(57) ABSTRACT

The present invention provides a method, apparatus and computer program product for providing improved functionality within instant messaging systems. In a preferred embodiment, the method begins when a user, the sender, decides to send a message to other users, the recipients. When the message is sent to the recipients, a separate chat window is opened for the sender, on the sender's data processing system, for each separate recipient of the message. A separate chat window is also opened for each recipient of the message on the recipient's data processing system. The chat window on the recipient's data processing system only allows the recipient to communicate with the sender, and not with the other recipients. Additionally, the sender has the option of having his chat window close automatically after sending a message.

### BACKGROUND OF THE INVENTION

1. Technical Field

The present invention relates generally to information processing systems, and more particularly, to a method and system for improved functionality within instant messaging systems.

2. Description of Related Art

Modern computing technology has resulted in immensely complicated and ever-changing environments. One such environment is the Internet, which is also referred to as an “internetwork.” The Internet is a set of computer networks, possibly dissimilar, joined together by means of gateways that handle data transfer and the conversion of messages from a protocol of the sending network to a protocol used by the receiving network. When capitalized, the term “internet” refers to a collection of networks and gateways that use the TCP/IP suite of protocols. Currently, the most commonly employed method of transferring data over the Internet is to employ the World Wide Web environment, also called the “Web”.

The existence and continued acceptance and use of the Web and the Internet have resulted in many new and useful applications becoming available to users of the Internet. One useful and popular application that most everyone with access to the Internet uses is electronic mail (email). An email is a method of personal communication without requiring face to face contact. An email account allows a user to communicate a message to an intended email recipient. This is true even if the recipient has a different service provider than the sender. Email is based on a standard communication protocol that allows the communication of messages between individuals that may have different service providers. To correspond across the standard communications protocols using email, all that is required is the recipient's email address.

A recent advancement in the area of email and other forms of personal communication, such as web conferencing, etc., is an application, which is growing in popularity, known as “instant messaging” or “IM”. IM systems are based on an architecture that usually includes at least one instant messaging server (“IM server”), multiple clients, and software that allows the multiple clients to communicate with each other and with the IM server. A typical IM exchange involves two or more users engaging in an online conversation, or chat, without the requirement of entering a message recipient's email address prior to each transmission. With IM, a user sends an instant message to a recipient by typing a message on a keyboard and pressing a transmit or send button, or by simply hitting the enter key, or in the case of voice activated software, simply by speaking. In this streamlined manner, IM users can chat by corresponding textually at a tempo approaching a conversational pace. Because IM enables a contemporaneous textual exchange, it is now a preferred method of distance communication that has a myriad of potential uses.

While a typical IM system is a single system such as AOL Instant Messenger, ICQ, Yahoo! Messenger, MSN chat, and Internet Relay Chat (IRC), some hybrid systems, such as Trillian, Fire, and Everybuddy, allow a user to send instant messages to people on various other systems from that single system, it should be understood that the present invention encompasses all of these types of systems.

IM has become an important part of both personal and business communications. At home, publicly available IM messaging clients can be used as a means of long distance communication between relatives and friends.

IM is a potentially valuable tool in the business world because decisions often must be made quickly. The popularity of IM in the business place stems from the capability of a user to continuously detect the presence of others, and instantly collaborate with them online. IM also has the potential to be useful in call centers for businesses.

As IM is becoming a very valuable tool for both personal and business communications, with millions of users communicating using IM systems every day, functionality and usability enhancements are important to the continued success of this communication tool.

Various IM applications are provided from many sources but all such applications have many common features. For example, these applications permit a user to chat with an individual person and, typically, there is also a feature allowing invitees to request that additional people join a chat. In general, IM applications enable a user to register with an IM server on the Web or other network using the Internet. Such applications may also be accessed through other local area and wide area networks as well. When a user accesses an IM application, the user inputs the user's personal information together with a user identification (ID) and a password. The user is then enabled to designate a user name which will be used to identify the user in subsequent chat sessions or in sending messages to and receiving messages from other users. IM server clients can exchange text messages, audio, data and other types of multimedia files. Clients may also have a list of users called “buddy lists” that are known to them as friends, coworkers, or other user acquaintances.

Current IM applications do, however, have serious flaws and/or shortcomings which must be corrected if IM is to continue to thrive as a communications vehicle. “Join” is a chat feature that allows a group chat meeting but this feature is limited in how it is set up to invite users and it is also limited to joining all the invitees to the same chat window.

For example, IBM NotesBuddy has an invite feature. From an open chat window, via its “Menu”, one can choose to “invite others”. That brings up a new window whereby one can press the invite button to search for individual users or can drag and drop an individual (one at a time) or a group (one at a time) into the window list.

Other problems with the current IM applications include a lack of a broadcast and close feature. No easy way exists to broadcast and open private chats, the invite window isn't as usable as it could be, and no way exists to queue broadcasts to off-line people.

Therefore, it would be advantageous to provide a method, apparatus, and computer software program product for providing improved functionality within instant messaging systems.

### SUMMARY OF THE INVENTION

The present invention provides a method, apparatus and computer program product for providing improved functionality within instant messaging systems. In a preferred embodiment, the method begins when a user, the sender, decides to send a message to other users, the recipients. When the message is sent to the recipients, a separate chat window is opened for the sender, on the sender's data processing system, for each separate recipient of the message. A separate chat window is also opened for each recipient of the message on the recipient's data processing system. The chat window on the recipient's data processing system only allows the recipient to communicate with the sender, and not with the other recipients. Additionally, the sender has the option of having his chat window close automatically after sending a message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the invention may be implemented.

FIG. 2 is a block diagram of a data processing system that may be implemented as a server in accordance with a preferred embodiment of the invention.

FIG. 3 is a block diagram illustrating a data processing system in which the invention may be implemented.

FIG. 4 depicts a typical chat window in an IM application.

FIG. 5 depicts typical menu options for a chat window.

FIG. 6 depicts a typical invite others pop-up window modified to include additional features, in accordance with a preferred embodiment of the invention.

FIG. 7 depicts a typical IM list of groups/people in a buddy list.

FIG. 8 is a flowchart that illustrates a method for sending an IM message, in accordance with a preferred embodiment of the invention.

### DETAILED DESCRIPTION OF THE PREFERRED EMBODIMENT

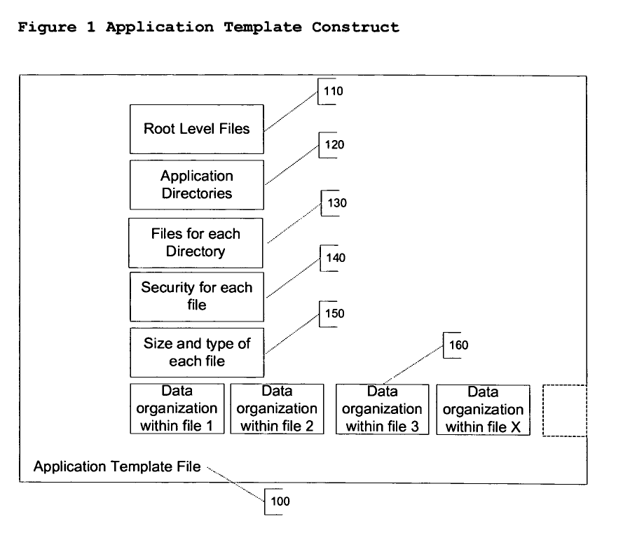

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a Local Area Network (LAN), or a Wide Area Network (WAN). FIG. 1 is intended as an example, and not as an architectural limitation for the present invention.

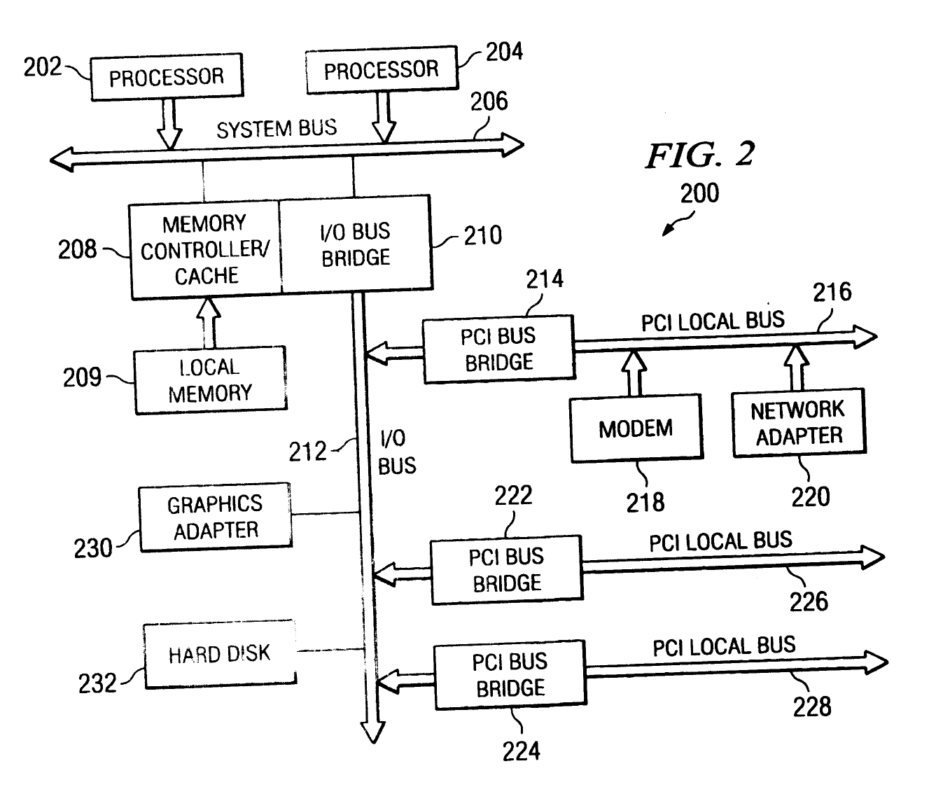

Referring to FIG. 2, a block diagram of a data processing system that may be implemented as a server, such as server 104 in FIG. 1, is depicted in accordance with a preferred embodiment of the present invention. Data processing system 200 may be a Symmetric MultiProcessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral Component Interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

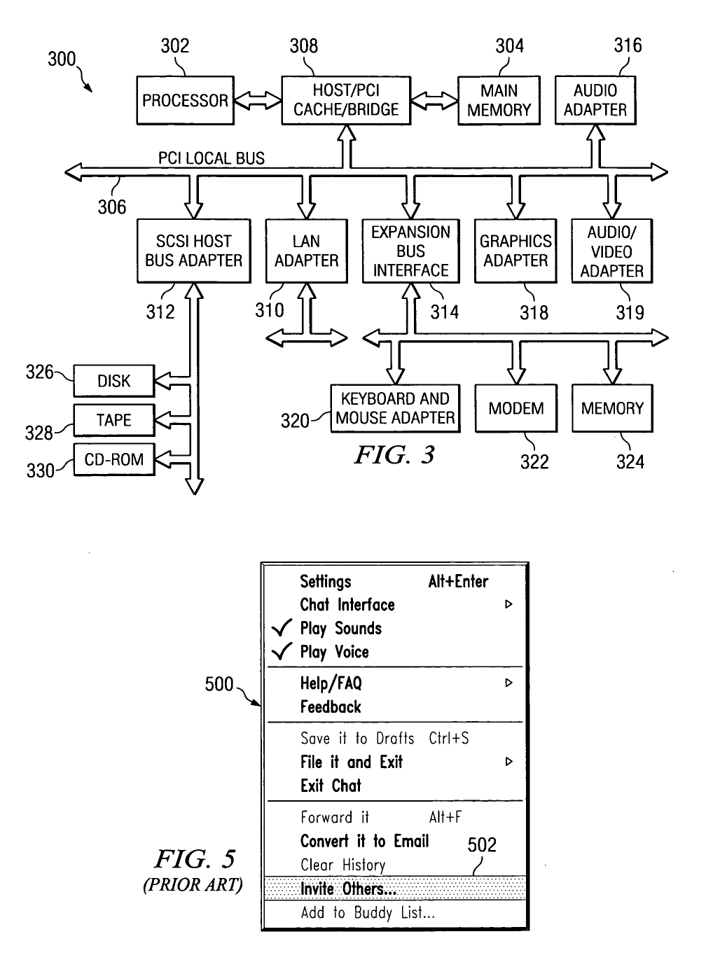

With reference now to FIG. 3, a block diagram illustrating a data processing system is depicted in which the present invention may be implemented. Data processing system 300 is an example of a client computer. Data processing system 300 employs a PCI local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, LAN adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash Read-Only Memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

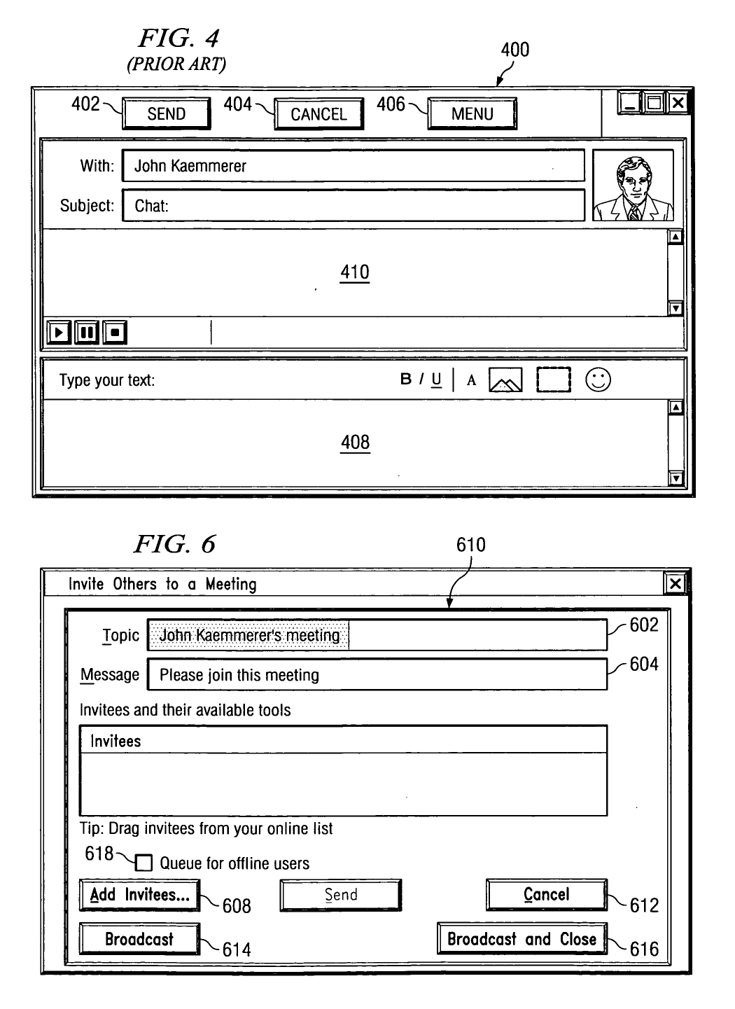

Referring now to FIG. 4, FIG. 4 depicts a typical chat window in an IM application, as it exists today. Chat window 400 has send button 402, cancel button 404 and menu button 406. Chat window 400 also has text area 408, where a user types in the message they wish to send and display area 410, which displays the entire conversation, both sent and received messages. Currently, a chat window is opened by one user requesting a session with another user. The one user selects menu button 406 and then a list of options appear, as seen in FIG. 5.

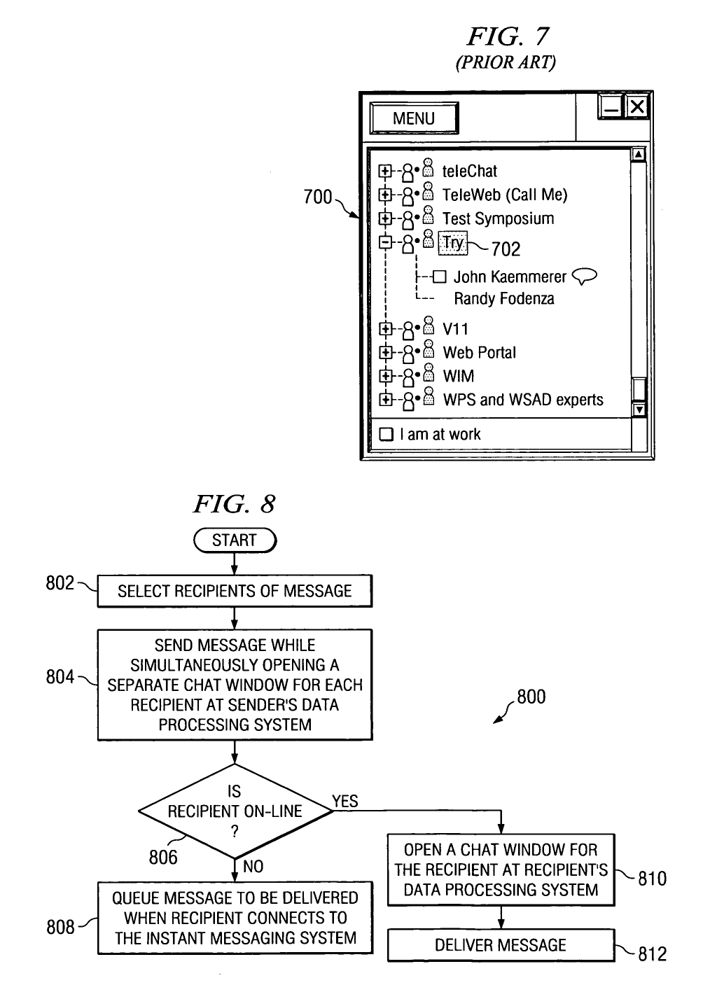

FIG. 5 depicts typical menu options for a chat window. Menu options 500 shows typical options that a user might see if the user were to select menu button 406. By selecting the invite others option 502; the user can invite other users to join the user's chat. Selecting invite others option 502 causes a pop-up window, such as invite others pop-up window 600 in FIG. 6, to appear that allows the user to specify a particular user or to drag those users that the user wants to invite to the user's single chat window. The drag option allows for dragging a single user or a group that contains multiple users. For example, in FIG. 7, the user might drag the group Try 702 into the Invitees window of FIG. 6. This would add users John and Randy to the user's invite list.

FIG. 6 depicts a typical invite others pop-up window modified to include additional features, in accordance with a preferred embodiment of the invention. Invite others pop-up window 600 has a topic field 602, which is the title of the message, a message field 604, which is the text message that will be sent to the invitees, invite window 606, which contains the list of invitees to the chat, add invitees button 608, send button 610, cancel button 612, broadcast button 614, broadcast and close button 616 and check box 618.

Normally, a sender can only send an invitation to a recipient that is currently on-line. The present invention solves this deficiency by allowing a sender to drag or add off-line recipients to the list of invitees. As the invite window list is being modified by the sender, this feature would allow a recipient who was off-line to show as on-line when they log in or change state to “Active” as opposed to “Do not disturb”, and vice-versa. There is also a selection, possibly in the form of a check box, such as check box 618, or a selection in an options menu, but the form could vary depending upon the implementation, to either “discard” or “queue” off-line recipients so that when a message is sent or a broadcast occurs, one of two things happens.

If a “queue” type request was chosen, by marking check box 618 for example, then when the broadcast is made or the message is sent to all on-line recipients, the message is also time-stamped and saved on the server end for off-line recipients. As a recipient logs on-line, or connects to the instant messaging system, that recipient would then receive the message from the server. There could be a check made so that messages sent in this form are only sent within the same day, within 8 hours, or some predefined time limit. That way the server could discard messages that fell outside the limit. In addition, as the original sender's local time is known, when the message finally reaches the recipient, there could be a timestamp indicating when the sender first sent the message. For example, the message might say broadcasted on Oct. 25, 2004 at 1:42 pm CST. An example of the usefulness of this capability would be the case where a sender needs to leave for the day. The sender would like to let his team know that he is gone. Therefore, the sender decides to include (queue) off-line people. The sender then drags his group to his invite list and presses broadcast. The message is now broadcast to all those who are on-line. The recipients that are off-line get queued on the server end and the message is sent by the server when they become on-line. If instead “discard” was chosen, then the broadcast is made or the message is sent and any recipient that is off-line at that time will not receive a message.

The present invention adds other new capabilities to these chat options, including the capability of broadcasting invitations. Broadcast button 614 allows a sender to broadcast a message to other users. Broadcasting a message is different than sending a message. Sending means that when an IM transmits a message, the sender's chat window remains open and a chat window is opened on the recipient's data processing system for each recipient. In contrast, broadcasting means that when an IM transmits a message, separate chat windows are opened for the sender, on the sender's data processing system, one for each recipient of the message and a separate chat window is opened on the recipient's data processing system for each recipient. Therefore, each recipient can only chat directly with the sender, and not with the other recipients.

This feature is useful, for example, in the instance when a sender does not want everyone to know what the others are chatting to him about. Therefore, joining all the users to the same chat window is not practical. The sender could individually invite each user, but that would take a lot of time and is a slow, repetitious process.

Broadcast and close button 616 causes invitations to be broadcast to the invitees; but rather than a opening a separate chat window for the sender, on the sender's data processing system, for each recipient of the message, the sender's chat window is closed after the invitation is sent and no other chat windows are opened for the sender. In an alternate embodiment, the invitation window could be opened from a menu selection that does not require the opening a chat window on the sender's data processing system. In such a case, once the invitations are broadcast to the invitees, the invitation window would close and no chat window is ever opened for the sender.

This feature is useful in the instance when the sender needs a quick way to get out a message but does not necessarily need a response. For example, take the case of when there's an urgent meeting and the sender has to run to the conference room to start it up. The sender needs to notify his/her team to come to the meeting urgently. There needs to be a way where the sender can quickly tell his/her team to come to the location right away. Since the sender doesn't need any response (as the sender is going to the conference room now), the sender doesn't want the chat window to remain open.

While the above described invention's implementation has been described in terms of modifying a pop-up window to included additional buttons and features, those skilled in the art will recognize many other ways of implementing the present invention, including, but not limited to, adding choices to a menu, such as options menu 500 in FIG. 5, called “broadcast”, “broadcast and close” and “invite separately”.

FIG. 7 depicts a typical IM list of groups/people in a buddy list. Buddy list window 700 is a typical list of people and/or groups that a user might have stored on their buddy list of an IM application. Try 702 is a group that contains the users John and Randy. Groups or individual users from this list can be dragged into an invitation window, such as invite others pop-up window 600 in FIG. 6. Currently, if a group which contains multiple on-line people is dragged into the invitation window, the individual addresses are loaded and seen. The group name is lost and is no longer apparent within the invitation window.

The present invention solves this deficiency by also showing the group name with the list of individuals from that group indented underneath it. This identification of individuals within a group is useful for many reasons. For instance, the sender may have added the wrong group by mistake. Previously it would have been very difficult to uninvite this group. The sender would have to remember which users were parts of that group and delete those users individually. In accordance with the present invention, the sender now sees each group and can select one and press the “delete” key to remove a group and all those individual users that came from it.

Additionally, now that added groups show individual users indented under it, the sender has a quick way to select one or more users under that group and press the “delete” key to remove just those users. Having the individual users appearing indented under the group name in the invitation window also helps in the case where the sender wants to recall who's from what group as the sender adds other groups or individuals. The sender can tell which groups have already been included. If multiple groups are in the invitation window, each on-line user in each group is listed. It is possible that the same user might be included in multiple groups. Because of maintaining the list of users in each group on the invitation window, that individual user would appear multiple times. However, the present invention only sends one invitation to that user.

FIG. 8 is a flowchart that illustrates a method for sending an IM message, in accordance with a preferred embodiment of the invention. The method is designated by reference number 800 and begins when the sender selects the recipients of his/her message (step 802). In one embodiment, the recipients are listed in an invitation window. In a preferred embodiment, group names along with the list of individuals from that group indented underneath it are shown in the invitation window. The message is then sent while simultaneously opening a separate chat window for each recipient of the message at the sender's location (step 804). A determination is made if each recipient is currently on-line (step 806). If a recipient is not currently on-line (a no output to step 806), the message is queued to be delivered to the recipient when the recipient becomes on-line (step 808). If a recipient is currently on-line (a yes output to step 806), a chat window is opened for the recipient at the recipient's location (step 810) and the message is delivered (step 812).

While the method has been described above in terms of sending a message to recipients, in a preferred embodiment, the method also applies to messages that are broadcast to recipients.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for improved functionality within an instant messaging system, the method comprising:
receiving user input from a user wherein the user input comprises a message and a plurality of recipients; and
attempting to initiate a separate instant messaging session with each recipient of the plurality of recipients.

2. The method of claim 1, wherein the plurality of recipients are listed in an invitation window.

3. The method of claim 2, further comprising:
retaining group names for the plurality of recipients within the invitation window.

4. The method of claim 1, further comprising:
responsive to establishing a separate instant messaging session with at least one recipient of the plurality of recipients, opening a separate chat window for each at least one recipient of the plurality of recipients such that each at least one recipient of the plurality of recipients can communicate only with the user.

5. The method of claim 4, further comprising:
opening a separate chat window for the user for each at least one recipient of the plurality of recipients.

6. The method of claim 4, further comprising:
responsive to a given instant messaging session being established successfully with a given recipient, sending one or messages from the user to the given recipient without opening a chat window for the given instant messaging session at the user's data processing system.

7. The method of claim 1, further comprising:
responsive to a given instant messaging session not being established successfully with a given recipient, storing one or more messages at a server for delivery to the given recipient when the given recipient connects to the instant messaging system.

8. The method of claim 2, further comprising:
responsive to a determination that a recipient is included more than once in the plurality of recipients listed in the invitation window, sending only one invitation to the recipient.

9. A computer program product in a computer readable medium for improved functionality within an instant messaging system, the computer program product comprising:
first instructions for receiving user input wherein the user input comprises a message and a plurality of recipients; and
second instructions for attempting to initiate a separate instant messaging session with each recipient of the plurality of recipients.

10. The computer program product of claim 9, wherein the plurality of recipients are listed in an invitation window

11. The computer program product of claim 10, further comprising:
third instructions for retaining group names for recipients within an invitation window.

12. The computer program product of claim 9, further comprising:
fourth instructions, responsive to establishing a separate instant messaging session with at least one recipient of the plurality of recipients, for opening a separate chat window for each of the at least one recipient of the plurality of recipients such that each of the at least one recipient of the plurality of recipients can communicate only with the user.

13. The computer program product of claim 12, further comprising:
fifth instructions for opening a separate chat window for the user for each of the at least one recipient of the plurality of recipients.

14. The computer program product of claim 9, further comprising:
sixth instructions, responsive to a given instant messaging session not being established successfully with a given recipient, for storing one or more messages at a server for delivery to the given recipient when the given recipient connects to the instant messaging system.

15. A data processing system for improved functionality within an instant messaging system, the data processing system comprising:
receiving mechanism for receiving user input wherein the user input comprises a message and a plurality of recipients; and
initiating mechanism for attempting to initiate a separate instant messaging session with each recipient of the plurality of recipients.

16. The data processing system of claim 15, wherein the plurality of recipients are listed in an invitation window

17. The data processing system of claim 16, further comprising:
retaining mechanism for retaining group names for recipients within an invitation window.

18. The data processing system of claim 15, further comprising:
opening mechanism, responsive to establishing a separate instant messaging session with at least one recipient of the plurality of recipients, for opening a separate chat window for each of the at least one recipient of the plurality of recipients such that each of the at least one recipient of the plurality of recipients can communicate only with the user.

19. The data processing system of claim 18, further comprising:
opening mechanism for opening a separate chat window for the user for each of the at least one recipient of the plurality of recipients.

20. The data processing system of claim 17, further comprising:
storing mechanism, responsive to a given instant messaging session not being established successfully with a given recipient, for storing one or more messages at a server for delivery to the given recipient when the given recipient connects to the instant messaging system.
